(19) United States
(12) Patent Application Publication
(10) Pub. No.: US 2025/0102020 A1
(43) Pub. Date: Mar. 27, 2025

(54) CONSTANT-VELOCITY SLIP BALL JOINT

(71) Applicants: GKN Driveline Deutschland GmbH, Offenbach am Main (DE); GKN Driveline International GmbH, Lohmar (DE)

(72) Inventors: Orkan Eryilmaz, Lohmar (DE); Benjamin Panhirsch, Offenbach (DE)

(21) Appl. No.: 18/833,944

(22) PCT Filed: Feb. 17, 2022
(86) PCT No.: PCT/EP2022/053986

§ 371 Date: Jul. 29, 2024

(51) Int. Cl. F16D 3/227; F16D 3/223

(52) U.S. Cl. CPC F16D 3/227; F16D 2003/22306; F16D 2003/22309

(57) ABSTRACT

A ball constant velocity sliding joint, comprises an outer joint part with an axis of rotation and with outer ball tracks and outer center lines, an inner joint part with inner ball tracks and inner center lines, a plurality of torque-transmitting balls, which are each guided in outer ball tracks and inner ball tracks assigned to one another and forming track pairs; and a cage, which is provided with a plurality of cage windows, which each receive one or more of the balls; wherein the cage has a web along a circumferential direction between the cage windows, which web is guided via a respective spherical contact surface at least on the outer joint part or on the inner joint part.

### CROSS REFERENCE TO RELATED APPLICATIONS

This application is a national stage of, and claims priority to, Patent Cooperation Treaty Application No. PCT/EP2022/053986, filed on Feb. 17, 2022, which application is hereby incorporated herein by reference in its entirety.

### BACKGROUND

With ball constant velocity sliding joints, the inner joint parts can move relative to the outer joint parts in the axial direction. The total displacement (i.e. the maximum distance by which the inner joint part can be displaced relative to the outer joint part) is at least five millimeters in a sliding joint.

At least some of the outer ball tracks and at least some of the inner ball tracks can have an (arbitrarily oriented) track-inclination angle (inclination angle) in relation to the axis of rotation or can also run without a track-inclination angle, i.e. parallel to the axial direction or axis of rotation. If the joint is in an extended position or arrangement (i.e. the inner joint part is not articulated relative to the outer joint part), the inner joint part can be displaced relative to the outer joint part along the common axis of rotation so that the axes of rotation remain coaxial with each other.

In particular, a ball track base (i.e. in the case of the outer ball tracks, the regions of the ball tracks that are arranged at a maximum distance from the axis of rotation; in the case of the inner ball tracks, the regions of the ball tracks that are arranged at a minimum distance from an axis of rotation of the joint inner part) or a center line (the course of a ball center point during the movement of a ball along a ball track) of each ball track along the displacement path has a (substantially) constant distance from the axis of rotation along a radial direction. However, there are also known designs of ball constant velocity sliding joints in which the ball track base or the center line do not have a constant distance from the axis of rotation. The distance to the axis of rotation is the same (only) for opposing ball tracks, but is not constant over the displacement movement or along the ball track.

When the inner joint part of the is articulated, the inner joint part is pivoted from the extended position (axis of rotation of the outer joint part and axis of rotation of the inner joint part are arranged coaxially to each other) into a (deviating) articulated position. The axis of rotation of the outer joint part and the axis of rotation of the inner joint part then form an angle of articulation (deviating from “0” degrees).

### SUMMARY

The present disclosure relates to a ball constant velocity sliding joint (hereinafter also referred to as joint), which can be installed in side shaft arrangements or longitudinal shaft arrangements in motor vehicles. The ball constant velocity sliding joint can be used in floating joint-shaft arrangements in which a ball constant velocity sliding joint is arranged at each end of a torque-transmitting shaft. Such joint-shaft arrangements can be used in rear-wheel drive motor vehicles in the area of the rear axle.

The ball constant velocity sliding joint herein comprises at least one outer joint part with an axis of rotation and with outer ball tracks and with outer center lines, an inner joint part with inner ball tracks and inner center lines, a plurality of torque-transmitting balls which are each guided in outer ball tracks and inner ball tracks assigned to one another and forming track pairs, and a cage which is provided with a plurality of cage windows which each accommodate one or more of the balls. The cage has a respective web along a circumferential direction between the cage windows, which is guided via a respective spherical contact surface on the outer joint part and/or on the inner joint part. The center lines extend along the ball tracks from a first end region via a middle region to a second end region. In an extended arrangement of the ball constant velocity sliding joint, the center lines of at least some of the track pairs run inclined in the circumferential direction. The center lines therefore have a gradient relative to an axial direction which is parallel to the axis of rotation. The center lines of a track pair are inclined in opposite directions.

When the inner joint part is displaced relative to the outer part of the joint, the balls in the ball tracks perform a movement guided by the track (e.g., rolling, sliding, gliding, etc.). Preferably, the cage moves by half the distance of the displacement of the inner joint part relative to the outer joint part. There is no relative rotation of the inner joint part, outer joint part and cage in the circumferential direction. The inclination of the ball tracks with respect to the axial direction therefore requires that the cage has sufficiently wide cage windows so that the balls can perform the displacement along the circumferential direction when the joint parts are relatively displaced along the axial direction.

Such ball constant velocity sliding joints with inclined ball tracks have the problem that the ball tracks, with angles of inclination oriented tangentially, intersect each other, depending on the displacement length. It would then not be possible to operate the ball constant velocity sliding joint in this region (i.e., if the inner joint part was displaced far enough in relation to the outer joint part along the axis of rotation), as the balls would contact each other and there would be no force transmission surface between the ball tracks arranged adjacent to each other. If the ball is also to be as large as possible with a small packing size (largest diameter of the constant velocity ball bearing sliding joint) of the ball constant velocity sliding joint in order to be able to transmit high torques, the width of the cage window in ball constant velocity sliding joints works against the width of the web existing between the cage windows. However, the smaller the cross-sectional area of this web, the more susceptible the cage is to breakage.

Herein disclosed is ball constant velocity sliding joint in which a cage can be realized that has enhanced stability. The webs of the cage should be as wide as possible. At the same time, however, the packing size should not be increased.

A ball constant velocity sliding joint is described in claim 1. Advantageous further developments are the subject of the dependent claims. The features listed individually in the claims can be combined with each other in a technologically meaningful way and can be supplemented by explanatory facts from the description and/or details from the figures, whereby further embodiments of the invention are shown.

A ball constant velocity sliding joint is disclosed, comprising at least
an outer joint part with an axis of rotation and with outer ball tracks and outer center lines,
an inner joint part with inner ball tracks and inner center lines,
a plurality of torque-transmitting balls, each of which is guided in an associated outer ball track and inner ball track forming track pairs; and
a cage which is provided with a plurality of cage windows, each of which accommodates one or more of the balls, the cage having a web along a circumferential direction between the cage windows, which web is guided via a respective spherical contact surface on the outer joint part and/or on the inner joint part.

The center lines extend along the ball tracks from a first end region via a middle region to a second end region. The center lines of at least some of the track pairs are inclined in the circumferential direction, i.e., have a gradient relative to an axial direction which is parallel to the axis of rotation, with the center lines of a track pair being inclined in the opposite direction.

It is further provided
a) that an amount of the gradient of the center lines of at least one track pair (in particular half of the track pairs, preferably all track pairs) decreases progressively at least in an end region and starting from the center region; and/or
b) that two balls are arranged in a cage window and the associated track pairs are arranged along the circumferential direction at a smaller pitch to one another than one of these track pairs with a track pair arranged adjacently in the circumferential direction in each case.

Features a) and b) can be present alternatively or in combination.

The center line (the course of a ball center point during the movement of a ball along a ball track) of each ball track extends along the axis of rotation of each joint part or along the axial direction, starting from a first end region (in which the ball track begins) via the middle region to a second end region (in which the ball track ends). In known ball constant velocity sliding joints, the center lines have a constant gradient across all regions, i.e., a constant track-inclination angle or inclination angle.

The end regions are each of the same length (in a projection onto the axial direction). Further, all regions (end regions and middle region) are of the same length. The middle region is approximately twice as long as the end regions, which are each of the same length. Each region comprises at least 20% of a total length of the center line (in each case in a projection onto the axial direction).

The first embodiment of the ball constant velocity sliding joint comprises that an amount of the gradient of the center lines of at least one track pair decreases progressively, starting from the middle region, at least in an end region and. The amount of the gradient decreases, starting from the middle region, in both end regions, for example, in the same way.

The spherical paths or center lines distributed along the circumferential direction can also be represented in an unwound state, i.e., not in a spatial but in a two-dimensional planar image. Center lines with a constant gradient are then represented as straight lines. The center lines proposed here with a progressively decreasing gradient are then shown in particular as an S-curve or sine curve.

The center lines in this unwound state have a freely definable shape in which individual partial shapes are connected to each other via a tangential transition. The at least one center line has an at least partially curved course. The curvature can be constant or variable.

As a result of the progressively decreasing gradient of the center line starting from the middle region, more distance is created in the end regions along the circumferential direction between the ball tracks or the balls are displaced less far in the circumferential direction when the joint parts are displaced in opposite directions relative to the axial direction. This increased distance enables wider webs between the ball tracks and correspondingly wider webs of the cage between the cage windows.

Alternatively or additionally, the diameter of individual or all balls can also be increased so that the torque capacity or fatigue strength of the ball constant velocity sliding joint can be increased as a result of the larger diameter of the balls if the cage is sufficiently strong.

The second embodiment of the ball constant velocity sliding joint comprises that two balls are arranged in one cage window and the associated track pairs are arranged along the circumferential direction at a smaller pitch to each other than one of these track pairs with a track pair arranged adjacently in the circumferential direction.

In particular, a cage window that extends along the circumferential direction over two track pairs and therefore accommodates two balls does not have a web between these two balls. Corresponding contact surfaces on the outer joint part and/or on the inner joint part do not need to be provided. This circumstance is used to arrange the ball tracks of these two track pairs as close together as possible in relation to the circumferential direction (small pitch, i.e. small angular distance), so that the track pairs (which guide balls which are arranged in a different cage window) can be arranged as distant from each other as possible (large pitch, i.e. large angular distance). Between these ball tracks, which are arranged as distant from each other as possible, a correspondingly wide web of the cage can be provided in the circumferential direction, whereby in particular correspondingly large contact surfaces can be provided on the outer joint part and/or the inner joint part.

Alternatively or additionally, a diameter of individual balls or all balls can be enlarged (here too) so that a torque capacity or fatigue strength of the ball constant velocity sliding joint can be increased as a result of the larger diameter of the balls, provided the cage is sufficiently strong.

The different embodiments described can be realized independently of each other or in combination on a ball constant velocity sliding joint.

The gradient is constant at least in the middle region.

At least the two track pairs whose balls are arranged in a common cage window (ball constant velocity sliding joint according to the second embodiment) can each have center lines with an exclusively constant gradient.

At least the two track pairs, the balls of which are arranged in a common cage window (ball constant velocity sliding joint according to the second embodiment), can have center lines with a gradient whose amount decreases progressively at least in an end region and starting from the middle region (ball constant velocity sliding joint according to the first embodiment).

The ball constant velocity sliding joint has 6+2n balls, with n=0, 1, 2, . . . (i.e., 6, 8, 10, 12, etc.). Along the circumferential direction, the track pairs alternate between center lines with an exclusively constant gradient and center lines with a gradient whose amount decreases progressively, starting from the middle region, at least in an end region.

The gradient corresponds to an angle of inclination of the center line relative to the axial direction, whereby the angle of inclination is at most 16 degrees.

The angle of inclination has a value in the range from 2 to 16 degrees of angle.

With an elongated arrangement of the ball constant velocity sliding joint, the center lines of at least some of the track pairs run at an essentially constant distance from the axis of rotation (i.e., there is no tilt angle, or the tilt angle of the ball tracks is zero degrees of angle).

The inner and outer ball tracks are inclined by a (constant) tilt angle relative to the axial direction in a radial direction. The ball tracks of a pair of tracks are tilted in the same direction. As a result of the tilt angle, the center lines of a pair of tracks are arranged at a smaller distance from the axis of rotation in one end region and at a greater distance from the axis of rotation in the other end region.

The tilt angle has a value in the range of 2 to 16 degrees.

Adjacently arranged inner ball tracks and adjacently arranged outer ball tracks are each tilted in different directions in the circumferential direction.

The gradient corresponds to an angle of inclination of the center line relative to the axial direction. At least some of the track pairs (with tilt angles greater than zero degrees) have inner ball tracks and outer ball tracks whose center lines have an inclination angle of zero degrees.

The ball constant velocity sliding joint has balls with different diameters. The balls of opposite track pairs each have the same diameter.

The inner joint part can be displaced by at least five millimeters in the axial direction relative to the outer joint part.

Furthermore, a motor vehicle is proposed which has at least one ball constant velocity sliding joint proposed here. The ball constant velocity sliding joint is proposed for use in a passenger car.

Furthermore, a motor vehicle with a drive unit and wheels is proposed, wherein at least one ball constant velocity sliding joint such as the described ball constant velocity sliding joint is designed to transmit torques from the drive unit to the wheels.

The explanations of the ball constant velocity sliding joint are particularly applicable to the motor vehicle and vice versa.

The use of indefinite articles (“an”, “a”), in particular in the claims and the description reproducing them, is to be understood as such and not as a number word. Accordingly, terms or components introduced thereby are to be understood as being present at least once and, in particular, as being present more than once.

As a precaution, it should be noted that the number words used here (“first”, “second”, . . . ) are primarily (only) used to distinguish between several similar objects, quantities or processes, i.e. in particular they do not necessarily specify any dependency and/or sequence of these objects, quantities or processes in relation to one another. If a dependency and/or sequence is required, this is explicitly stated here or is obvious to the person skilled in the art when studying the specific embodiment described. Insofar as a component may occur more than once (“at least one”), the description of one of these components may apply equally to all or some of the plurality of these components, but this is not mandatory.

### BRIEF SUMMARY OF THE DRAWINGS

The invention and the technical context are explained in more detail below with reference to the accompanying figures. It should be noted that the invention is not intended to be limited by the design variants given. In particular, unless explicitly shown otherwise, it is also possible to extract partial aspects of the facts explained in the figures and to combine them with other components and findings from the present description. In particular, it should be noted that the figures and especially the proportions shown are only schematic. The figures show:

FIG. 1: a motor vehicle in a plan view;

FIG. 2: a ball constant velocity sliding joint in a frontal view along the axial direction;

FIG. 3: the ball constant velocity sliding joint according to FIG. 2 in a side view in section;

FIG. 4: an unwound state of the ball tracks of a joint;

FIG. 5: a comparison of the different ball paths according to FIG. 4;

FIG. 6: an unwound state of the ball paths of a known joint;

FIG. 7: an unwound state of the ball tracks of a joint according to a first design variant;

FIG. 8: an unwound state of the ball tracks of a joint according to a second design variant; and

FIG. 9: an unwound state of the ball tracks of a joint according to a third design variant.

### DESCRIPTION

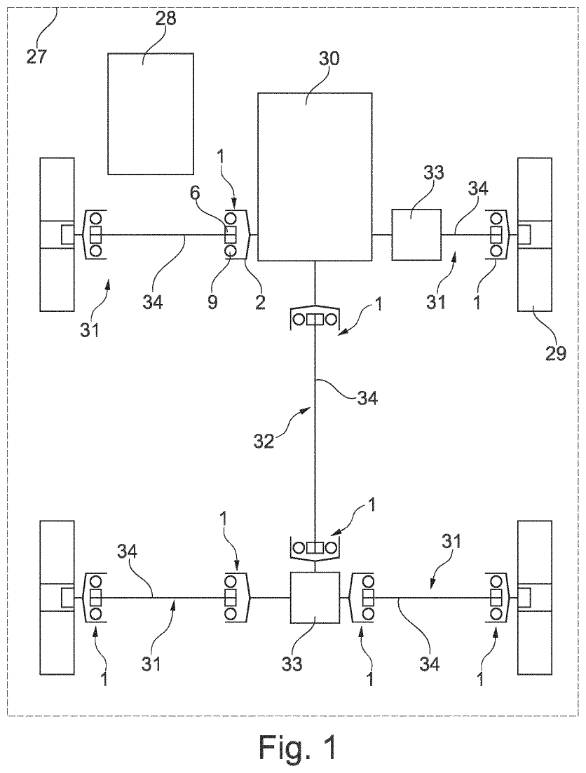

FIG. 1 shows a schematic top view of a motor vehicle 27. The motor vehicle 27 comprises a drive unit 28 (engine) and a gearbox 30. Torques are transmitted from the drive unit 28 via the gearbox 30 to several joint arrangements 31, 32. Two side shaft arrangements 31 are shown in the area of the front axle (here at the top of the picture). One side shaft arrangement 31 (on the right in FIG. 1) is connected to the gearbox 30 via a differential 33.

Starting from the gearbox 30, a torque is transmitted via the differential 33 or via the ball constant velocity sliding joint 1 of the other side shaft arrangement 31 (left in FIG. 1) with outer joint part 2, balls 9 and inner joint part 6 to a respective shaft 34 and from there to another ball constant velocity sliding joint 1 or to a constant velocity (fixed) joint which is connected to a wheel 29.

Furthermore, a torque can alternatively or additionally be transmitted from the gearbox 30 to a longitudinal shaft arrangement 32 via a ball constant velocity sliding joint 1. The torque is transmitted to a (rear axle) differential 33 via this longitudinal shaft arrangement 32. The torque is transmitted to a respective side shaft arrangement 31 via the (rear axle) differential 33. The side shaft arrangements 31 each comprise two ball constant velocity sliding joints 1, which are connected to each other by shafts 34.

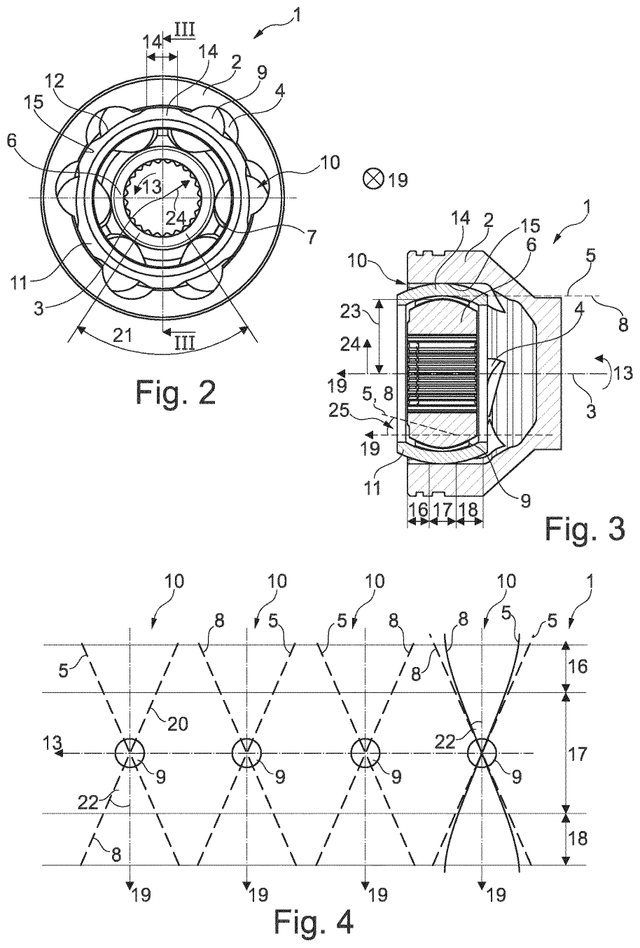

FIG. 2 shows a ball constant velocity sliding joint 1 in a frontal view along the axial direction 19. FIG. 3 shows a ball constant velocity sliding joint 1 in a lateral view in section (section III-III in FIG. 2). FIGS. 2 and 3 are described together below.

The ball constant velocity sliding joint 1 comprises an outer joint part 2 with an axis of rotation 3 and with outer ball tracks 4 and outer center lines 5, an inner joint part 6 with inner ball tracks 7 and inner center lines 8, a plurality of torque-transmitting balls 9, which are each guided in outer ball tracks 4 and inner ball tracks 7 assigned to one another and forming track pairs 10, and a cage 11, which is provided with a plurality of cage windows 12, each of which receives one or more of the balls 9, wherein the cage 9 has a web 14 along a circumferential direction 13 between the cage windows 12, which is guided on the outer joint part 2 via a respective spherical contact surface 15.

The inner joint part 6 is arranged in the outer joint part 2. Torque is transmitted between the inner joint part 6 to the outer joint part 2 via balls 9. The six balls 9 run in separate track pairs 10, which are each formed by inner ball tracks 7 and outer ball tracks 4. The cage 11 has six cage windows 12, in each of which a ball 9 is arranged. The webs 14, via which the cage 11 is supported on a contact surface 15 of the outer joint part 2, extend between the cage windows 12. In the articulated state (the extended arrangement is shown here) of the ball constant velocity sliding joint 1, the cage 12 guides the balls 9 to a common angle-halving plane. The inner joint part 6 has splines for a rotationally fixed connection with a shaft 34 (not shown here).

The outer joint part 2 has an opening side (via which the inner joint part 6 can be pushed into the outer joint part 2 along the axial direction) and a closed connection side. An inner joint part 6, a cage 11 and balls 9 can be arranged in the outer joint part 2 via the opening side. The cage 11 is guided via contact surfaces 15 that run at least partially parallel to the axial direction 19, so that the cage 11 can be displaced relative to the outer joint part 2 by an axial displacement movement.

In the extended arrangement of the ball constant velocity sliding joint 1, the center lines 5, 8 of the track pairs 10 run at an essentially constant distance 23 from the axis of rotation 3 (there is therefore no tilt angle 25, or the tilt angle 25 of the ball tracks 4, 7 is zero degrees).

The inner and outer ball tracks 4, 7 are tilted/inclined in a radial direction 24 by a (constant) tilt angle 25 relative to the axial direction 19 (only indicated in FIG. 3). The ball tracks 4, 7 of a pair of tracks 10 are tilted in the same direction. As a result of the tilt angle 25, the center lines 5, 8 of a pair of tracks 10 are arranged at a smaller distance 23 from the axis of rotation 3 in a first end region 16 and at a greater distance 23 from the axis of rotation 3 in the second end region 18.

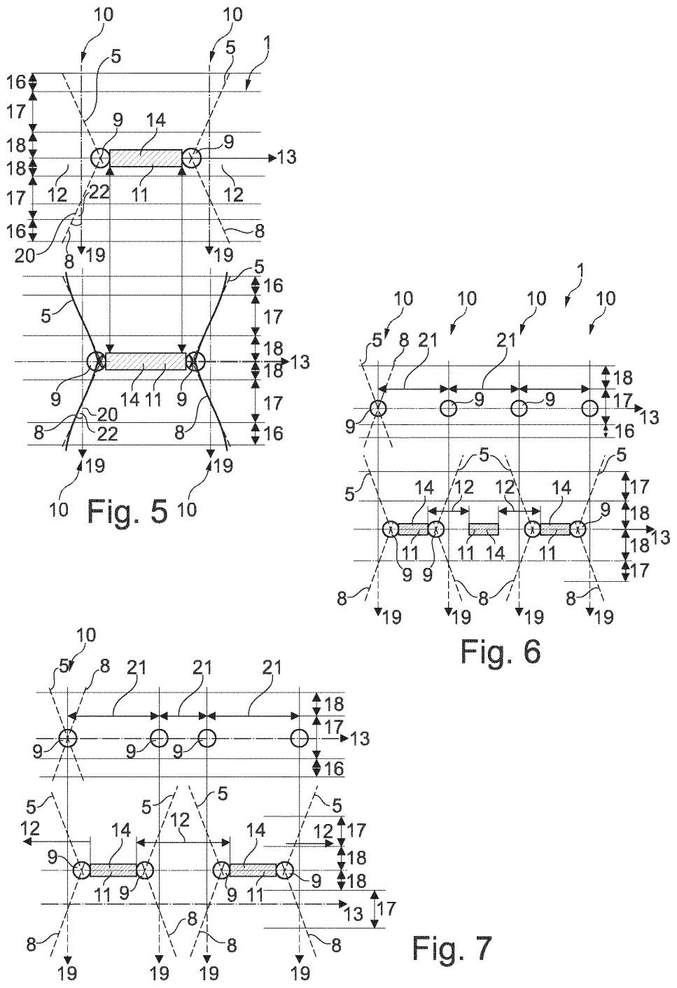

FIG. 4 shows an unwound state of the ball tracks 4, 7 of a ball constant velocity sliding joint 1. FIG. 5 shows a comparison of the different ball tracks 4, 7 according to FIG. 4. FIGS. 4 and 5 are described together in the following. Reference is made to the description with respect to FIGS. 2 and 3.

The ball tracks 4, 7 and center lines 5, 8 distributed along the circumferential direction 13 are shown in an unwound state, i.e., not in a spatial image but in a two-dimensional planar image. Center lines 5, 8 with a constant gradient 20 (see the three left-hand pairs of tracks 10 in FIG. 4) are shown as straight lines. The center lines 5, 8 with progressively decreasing gradient 20 are shown as an S-curve or sine curve (see the right-hand pair of paths 10 in FIG. 4).

The center line 5, 8 (the course of a ball center point during the movement of a ball 9 along a ball track 4, 7) of each ball track 4, 7 extends along the axis of rotation 3 of each joint part 2, 6 or along the axial direction 19, starting from a first end region 16 (where the ball track 4, 7 begins) via the middle region 17 to a second end region 18 (where the ball track 4, 7 ends). In known ball constant velocity sliding joints 1, the center lines 5, 8 have a constant gradient 20, i.e., a constant track-inclination angle or inclination angle 22, across all regions 16, 17, 18.

The center lines 5, 8 of the web pairs 10 run inclined in the circumferential direction 13, i.e. have a slope 20 relative to an axial direction 19 parallel to the axis of rotation 2, whereby the center lines 5, 8 of a track pair 10 are inclined in opposite directions. In the right-hand track pair 10 in FIG. 4, an amount of the gradient 20 of the center lines 5, 8 decreases progressively, starting from the center region 17, in both end regions 16, 18.

In FIG. 4, the balls 9 are each arranged in the middle of the middle region 17. In FIG. 5, joint parts 2, 6 are arranged displaced to each other along the axial direction 19, with the balls 9 being arranged in the end regions 16, 18 of the respective ball track 4, 7.

In FIG. 5, these different pairs of tracks 10 are shown opposite each other. In each case, two track pairs 10 arranged adjacent to each other along the circumferential direction 13 are shown with the ball tracks 4, 7 or center lines 5, 8 in an unwound state, i.e., not in a spatial image/illustration but in a two-dimensional planar image/illustration. The top of FIG. 5 shows two track pairs 10 of a known ball constant velocity sliding joint 1. At the bottom of FIG. 5, two track pairs 10 of the described ball constant velocity sliding joint 1 are shown according to the first embodiment.

The middle section 17 is approximately twice as long as the end sections 16, 18, which are of equal length.

The first embodiment of the ball constant velocity sliding joint 1 comprises that an amount of the gradient 20 of the center lines 5, 8 of the track pairs 10 decreases progressively, starting from the middle region 17, in both end regions 16, 18. The gradient 20 in the middle region 17 is constant.

As a result of the progressively decreasing gradient 20 of the center lines 5, 8 starting from the middle region 17, there is more distance in the end regions 16, 18 along the circumferential direction 13 between the ball tracks 4, 7 or the balls 9 are displaced less far in the circumferential direction 13 when the joint parts 2, 6 are displaced relative to the axial direction 19. This increased distance enables wider webs 14 between the ball tracks 4, 7 and correspondingly wider webs 14 of the cage 11 between the cage windows 12.

FIG. 6 shows an unwound of the ball tracks 4, 7 of a known joint 1. Reference is made to the explanations in FIGS. 2 to 5.

In FIG. 6 above, the balls 9 are each arranged in the middle of the middle region 17. In FIG. 6 below, joint parts 2, 6 are arranged displaced to each other along the axial direction 19, whereby the balls 9 are arranged in the end regions 16, 18 of the respective ball track 4, 7.

The track pairs 10 are arranged at the same pitch 21 (same angular distance) along the circumferential direction 13. The center lines 5, 8 of the track pairs 10 run inclined in the circumferential direction 13, i.e. they each have a constant gradient 20 with respect to an axial direction 19 which is parallel to the axis of rotation 3, whereby the center lines 5, 8 of a track pair 10 are inclined in opposite directions. A web 14 is arranged between each of the individual cage windows 12.

FIG. 7 shows an unwound state of the ball tracks 4, 7 of a joint 1 according to a first design variant (second embodiment). Reference is made to the comments on FIGS. 2 to 6.

In FIG. 7 above, the balls 9 are each arranged in the middle of the middle region 17. In FIG. 7 below, joint parts 2, 6 are arranged offset from one another (displaced to each other) along the axial direction 19, whereby the balls 9 are arranged in the end regions 16, 18 of the respective ball track 4, 7.

The track pairs 10 are arranged along the circumferential direction 13 at different pitches 21 (different angular spacing). The center lines 5, 8 of the track pairs 10 are inclined in the circumferential direction 13 and have a constant gradient 20 relative to an axial direction 19 which is parallel to the axis of rotation 2, whereby the center lines 5, 8 of a track pair 10 are inclined in opposite directions. The second embodiment of the ball constant velocity sliding joint 1 comprises that two balls 9 are arranged in one cage window 12 and the associated track pairs 10 are arranged along the circumferential direction 13 at a smaller pitch 21 to one another than one of these track pairs 10 with a track pair 10 arranged adjacently in the circumferential direction 13 in each case.

A web 14 is arranged between each of the individual cage windows 12. In contrast to the design of the joint 1 shown in FIG. 6, there are two balls 9 in each cage window 12. The remaining webs 14 have been extended compared to the webs 14 in FIG. 6.

A cage window 12 that extends along the circumferential direction 13 over two track pairs 10 and therefore accommodates two balls 9 does not have a web 14 between these two balls 9. Corresponding contact surfaces 15 on the outer joint part 2 and/or on the inner joint part 6 do not need to be provided. This circumstance is utilized in order to arrange the ball tracks 4, 7 of these two track pairs 10 as close as possible to each other with respect to the circumferential direction 13 (small pitch 21, i.e., small angular distance), so that the track pairs 10 (which guide balls 9 arranged in another cage window 12) can be arranged as distant from each other as possible (large pitch 21, i.e., large angular distance). A correspondingly wide web 14 of the cage 11 in the circumferential direction 13 can then be provided between these ball tracks 10 arranged as distant from each other as possible, whereby in particular correspondingly large contact surfaces 15 can be provided on the outer joint part 2 and/or the inner joint part 6.

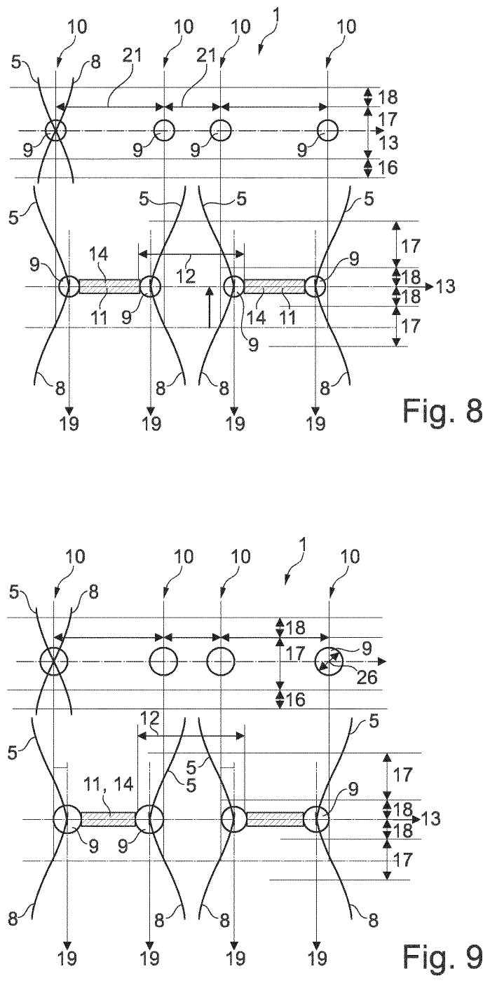

FIG. 8 shows an unwound state of the ball tracks 4, 7 of a joint 1 according to a second design variant. Reference is made to the comments on FIGS. 2 to 7.

In FIG. 8 above, the balls 9 are each arranged in the middle of the middle region 17. In FIG. 8 below, joint parts 2, 6 are arranged displaced from one another along the axial direction 19, whereby the balls 9 are arranged in the end regions 16, 18 of the respective ball track 4, 7.

The different embodiments described are realized here in combination on a ball constant velocity sliding joint 1.

In each case, two balls 9 are arranged in one cage window 12 and the associated track pairs 10 are arranged along the circumferential direction 13 at a smaller pitch 21 than one of these track pairs 10 with an adjacent track pair 10 in the circumferential direction 13 (second embodiment). The center lines 5, 8 of the track pairs 10 run inclined in the circumferential direction 13 and have a gradient 20 of the center lines 5, 8 in the end regions 16, 18 with respect to an axial direction 19 which is parallel to the axis of rotation 3 that decreases progressively starting from the center region 17 (first embodiment). The center lines 5, 8 of a track pair 10 are inclined in opposite directions.

FIG. 9 shows an unwound state of the ball tracks 4, 7 of a joint 1 according to a third design variant. Reference is made to the comments on FIG. 8.

Compared to FIG. 8, the diameters 26 of all balls 9 have been enlarged here, so that a torque capacity or fatigue strength of the ball constant velocity sliding joint 1 can be increased as a result of the larger diameter 26 of the balls 9 if the cage 11 is sufficiently strong.

### LIST OF REFERENCE SYMBOLS

1 ball constant velocity sliding joint
2 outer joint part
3 axis of rotation
4 outer ball track
5 outer center line
6 inner joint part
7 inner ball track
8 inner center line
9 ball
10 track pair
11 cage
12 cage window
13 circumferential direction
14 web
15 contact surface
16 first end region
17 middle region
18 second end region
19 axial direction
20 gradient
21 pitch
22 inclination angle
23 distance
24 radial direction
25 tilt angle
26 diameter
27 motor vehicle
28 drive unit
29 wheel
30 gearbox
31 side shaft arrangement
32 longitudinal shaft arrangement
33 differential
34 shaft

1.-15. (canceled)

16. A ball constant velocity sliding joint, comprising:
an outer joint part having an axis of rotation and outer ball tracks and outer center lines;
an inner joint part having inner ball tracks and inner center lines;
a plurality of torque transmitting balls each guided in associated outer ball tracks and inner ball tracks forming track pairs; and
a cage provided with a plurality of cage windows each receiving one or more of the balls;
wherein the cage includes respective webs along a circumferential direction between the cage windows, each the webs are guided via respective spherical contact surfaces at least on the joint outer part or on the joint inner part;
wherein the center lines extend along the ball tracks from a first end region via a middle region to a second end region;
wherein the center lines of at least some of the track pairs extend inclined in the circumferential direction such that they have a gradient relative to an axial direction which is parallel to the axis of rotation, wherein the center lines of a track pair are inclined in opposite directions;
wherein
a) an amount of the gradient of the center lines of at least one track pair decreases progressively, starting from the middle region at least in an end region; and/or
b) two balls are arranged in one cage window and the associated track pairs are arranged at a smaller pitch to one another along the circumferential direction than one of these track pairs with a track pair adjacently arranged in the circumferential direction.

17. The ball constant velocity sliding joint of claim 16, wherein the gradient is constant at least in the middle region.

18. The ball constant velocity sliding joint of claim 16, wherein at least the two track pairs, the balls of which are arranged in a common cage window, have center lines each with an exclusively constant gradient.

19. The ball constant velocity sliding joint of claim 16, wherein at least the two pairs of tracks, the balls of which are arranged in a common cage window, have center lines with a gradient, the amount of which decreases progressively, starting from the middle region, at least in an end region.

20. The ball constant velocity sliding joint of claim 16, comprising at least 6+2n balls, with n=0, 1, 2, . . . , wherein along the circumferential direction the track pairs alternately have center lines with an exclusively constant gradient and center lines with a gradient, the amount of which decreases progressively, starting from the middle region, at least in an end region.

21. The ball constant velocity sliding joint of claim 16, wherein the gradient corresponds to an angle of inclination of the center line relative to the axial direction, wherein the angle of inclination is at most 16 degrees.

22. The ball constant velocity sliding joint of claim 21, wherein the angle of inclination has a value in a range from 2 to 16 degrees.

23. The ball constant velocity sliding joint of claim 16, wherein, in an extended arrangement of the ball constant velocity sliding joint, the center lines of at least some of the track pairs extend at a substantially constant distance from the axis of rotation.

24. The ball constant velocity sliding joint of claim 16, wherein the outer ball tracks and inner ball tracks are inclined with respect to the axial direction in a radial direction by respective tilt angles.

25. The ball constant velocity sliding joint of claim 24, wherein the tilt angles have a value in a range from 2 to 16 degrees.

26. The ball constant velocity sliding joint of claim 16, wherein, in the circumferential direction, adjacently arranged outer ball tracks and adjacently arranged inner ball tracks are each tilted in different directions.

27. The ball constant velocity sliding joint of claim 16, wherein the gradient corresponds to an angle of inclination of the center line relative to the axial direction, wherein at least some of the track pairs have outer ball tracks and inner ball tracks whose center lines have an angle of inclination of zero degrees.

28. The ball constant velocity sliding joint of claim 16, wherein the ball constant velocity sliding joint has balls with different diameters.

29. The ball constant velocity sliding joint of claim 16, wherein the joint inner part is displaceable by at least five millimeters in the axial direction relative to the joint outer part.

30. A motor vehicle having a drive unit and wheels, comprising a ball constant velocity sliding joint arranged to transmit torques from the drive unit to the wheels, the ball constant velocity sliding joint, including:
an outer joint part having an axis of rotation and outer ball tracks and outer center lines;
an inner joint part having inner ball tracks and inner center lines;
a plurality of torque transmitting balls each guided in associated outer ball tracks and inner ball tracks forming track pairs; and
a cage provided with a plurality of cage windows each receiving one or more of the balls;
wherein the cage includes respective webs along a circumferential direction between the cage windows, each the webs are guided via respective spherical contact surfaces at least on the joint outer part or on the joint inner part;
wherein the center lines extend along the ball tracks from a first end region via a middle region to a second end region;
wherein the center lines of at least some of the track pairs extend inclined in the circumferential direction such that they have a gradient relative to an axial direction which is parallel to the axis of rotation, wherein the center lines of a track pair are inclined in opposite directions;
wherein
a) an amount of the gradient of the center lines of at least one track pair decreases progressively, starting from the middle region at least in an end region; and/or
b) two balls are arranged in one cage window and the associated track pairs are arranged at a smaller pitch to one another along the circumferential direction than one of these track pairs with a track pair adjacently arranged in the circumferential direction.
